(19) United States
(12) Patent Application Publication
(10) Pub. No.: US 2012/0087723 A1
(43) Pub. Date: Apr. 12, 2012

(54) Manual Quick-Release Latching System For Robotic End Effector

(76) Inventors: Richard Shafer, Webster, TX (US); William Robertson, Houston, TX (US)

(21) Appl. No.: 13/272,102

(22) Filed: Oct. 12, 2011

Related U.S. Application Data
(60) Provisional application No. 61/392,259, filed on Oct. 12, 2010.

(51) Int. Cl. F16B 17/00

(52) U.S. Cl. 403/361

(57) ABSTRACT

A manual quick-release latching system includes a first component and a second component. The first component includes a first component mating surface, a socket recessed into the first component and having an opening on the first component mating surface; and a first component retaining structure. The second component includes a second component mating surface, a second component retaining structure, and a latching mechanism. The mating surfaces are juxtaposed when the first component is slidingly engaged with the second component. The retaining structures slidingly engage one another in a first direction and interlock one another in a direction perpendicular to the first direction. The latching mechanism includes a part that can partially extend from the second component and enter the socket of the first component, to latch the first component with the second component by preventing the first component from sliding with respect to the second component in the first direction.

This application claims priority to U.S. Provisional Application No. 61/392,259, filed Oct. 12, 2010, the entire contents of which is incorporated by reference herein.

### FIELD OF THE INVENTION

This invention relates generally to electric manipulator arms such as those in the robotic and/or remotely operated vehicle fields, and more specifically to an improved and useful manual quick-release latching system to secure and stabilize remotely operated tools used with manipulator arms.

### BACKGROUND OF THE INVENTION

Remotely operated vehicles are used in various situations where unsafe or hostile conditions are present. For example, bomb disposal, fire rescue, chemical spills, and military combat are just a few uses in such situations. Remotely operated vehicles used in such situations typically include a manipulator arm for carrying out various tasks. At the end of the arm there may be an end effector, such as a gripper or other tools. Typically there exits an end effector interface that allows various types of tools to be attached to the manipulator arm. Such tools may include wrenches, screw drivers, drills, saws, grippers, shovels, sensors, etc. In many situations various tools are required to carry out a mission. Because the operator of the remotely operated vehicle is typically within about 50-102 meters of the robot during operation, it is possible for the vehicle to return to the operator to have a different tool placed on the manipulator arm.

As a result, it is desirable that the manipulator arm have a manual quick-release latching system. Such a system would allow for the quick interchange of needed tools and also provide a secure and stable platform for using the tool. It is also desirable that the system be reliable and of low cost.

Thus, there is a need in the electric manipulator field to create an improved and useful manual quick-release latching system to solve the problems mentioned above.

### SUMMARY OF THE INVENTION

The present invention provides for a latching system, including a first component, which includes at least one first component mating surface, a socket recessed into the first component and having an opening on the first component mating surface; and at least one first component retaining structure; and a second component, separate from the first component, the second component including at least one second component mating surface, configured to be juxtaposed to the first component mating surface when the first component is slidingly engaged with the second component, at least one second component retaining structure, configured to slidingly engage the first component retaining structure when the first component is slidingly engaged with the second component in a first direction and interlock the first component with the second component in a direction perpendicular to the first direction, and a latching mechanism comprising a part configured to partially extend outward from the second component mating surface in a direction perpendicular to the second component mating surface and fit into the socket to latch the first component with the second component by preventing the first component from sliding with respect to the second component in the first direction.

### BRIEF DESCRIPTION OF THE DRAWINGS

Several figures are provided herein to further the explanation of the present invention.

FIG. 1 is a front elevation view of a manual quick-release latching system in accordance with an embodiment of the invention.

FIG. 2 is a right-side elevation view of FIG. 1.

FIG. 3A is a right-side cross sectional view of the manual quick-release latching system of FIG. 1 in a latched state, in accordance with an embodiment of the invention, where the view is taken along plane 3-3 of FIG. 2.

FIG. 3B corresponds to FIG. 3A; however the manual quick-release latching system is illustrated in a released state, in accordance with an embodiment of the invention.

FIG. 4 is a top cross-sectional view of a second component of the manual quick-release latching system of FIG. 1 in a latched state, taken along the plane 4-4 of FIG. 1.

FIG. 5 is a perspective view of a bottom side of the sliding latch housed in the second component as illustrated in FIG. 4, in accordance with an embodiment of the invention.

FIG. 6 is an aerial view of an alternate embodiment of a T-shaped structure of FIG. 1, where a passive interface is tapered along a length of the T-shaped structure.

FIG. 7A is an enlarged view of a portion of FIG. 3A.

FIG. 7B is an enlarged view of a portion of FIG. 3B.

### DESCRIPTION OF THE PREFERRED EMBODIMENTS

The following description of the preferred embodiment of the invention is not intended to limit the invention to this preferred embodiment, but rather to enable any person skilled in the art to make and use this invention.

The invention described in this application seeks to solve the problems mentioned above by providing a manual quick-release latching system that allows for the manual quick-release of any tool attached to a manipulator arm. The manual quick-release latching system additionally provides a strong and stable connection between the tool and the manipulator arm, is reliable and of low cost

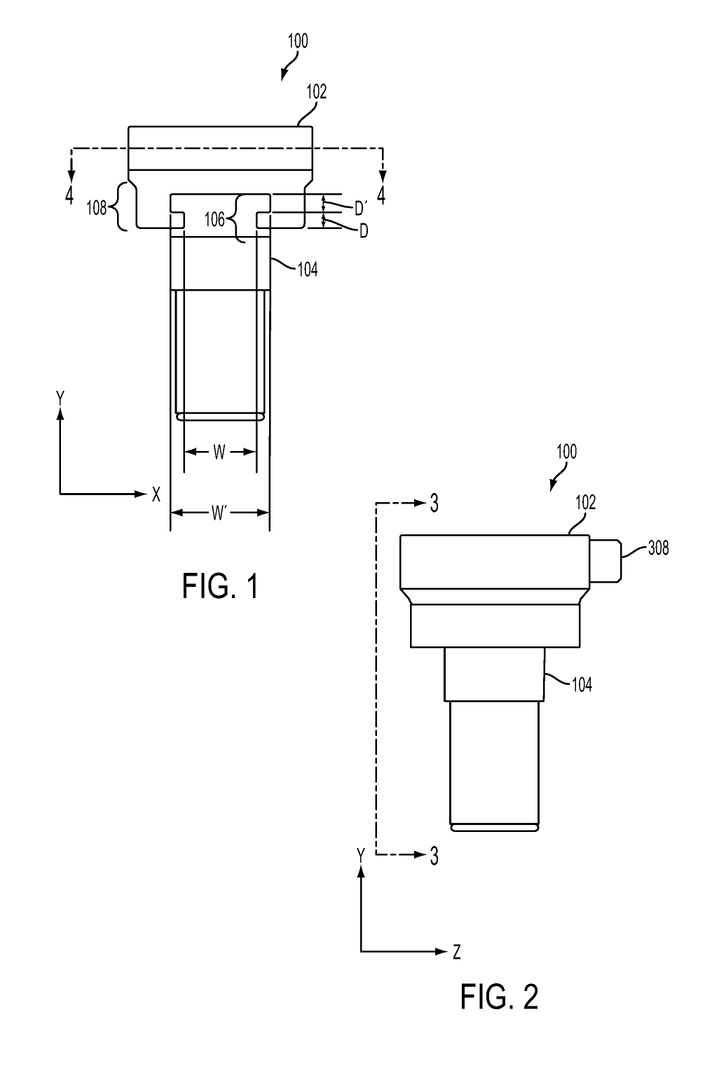

FIG. 1 is a front elevation view of a manual quick-release latching system 100 in accordance with an embodiment of the invention. FIG. 2 is a right-side elevation view of FIG. 1

In the illustrated embodiment, the manual quick-release latching system 100 may be comprised of a second component 102 and a first component 104. The second component 102 may be coupled to a tool (not shown). The first component 104 may be coupled to an end of a manipulator arm (not shown). In accordance with a method of use of the invention, it may be desirable to leave the second component 102 and the first component 104 coupled to their respective tool and mounting arm more or less indefinitely. By use of the manual quick-release latching system 100 as described herein, installation and removal of the tool (or multiple tools, each provided with a second component 102) may be affected quickly by easily sliding the tool(s) on or off the manipulator arm.

The portion of the first component 104 that engages a corresponding portion of the second component 102 will be referred to herein as the passive interface 106 or first retaining structure 106. The corresponding portion of the second component 102 will be referred to herein as the active interface 108 or second retaining structure 108.

The passive interface 106 may be any shape, provided that the shape includes retaining features and mating surfaces that correspond to respective shapes of retaining features and mating surfaces of the active interface 108. The shapes of the active and passive interfaces 108, 106 correspond when the active and passive interfaces 108, 106 readily slide on and off each other and, when engaged with each other, an amount of mechanical play between the active and passive interfaces 108, 106 is not so great as to prevent a strong and stable connection between the second and first components 102, 104. The dimensional clearances placed on the retaining features and mating surfaces of the active and passive interfaces 108, 106 determine the amount of mechanical “play” between the second and first components 102, 104 during insertion of the active interface 108 onto the passive interface 106. In one embodiment of the invention, the clearances are 0.010″ vertically and 0.006″ horizontally as oriented and embodied in FIG. 1.8.

As embodied in FIG. 1, the active interface 108 includes an undercut straight channel having a predetermined width W at the surface of the channel and a predetermined width W′ at the undercut portion of the channel, where W′ is greater than W. The depth of the narrower portion of the channel may be referred to as D, while D′ may be used to refer to the depth of the undercut portion of the channel.

The passive interface 106 may include a T-shaped structure configured to slide into the above-described channel, commonly referred as a T-Slot, of active interface 108, as shown in FIG. 1. In the “T-in-slot” or modified dado joint of FIG. 1, the sides of the passive interface 106 that are received in the channel of the active interface 108 may be flat, as opposed to, for example, circular. In such a configuration, second component 102 would not rotate upon the first component 104. Other configurations that would prevent rotation (if rotation was undesirable) are within the scope of the invention. An example of such an alternative configuration might be a dovetail joint configuration.

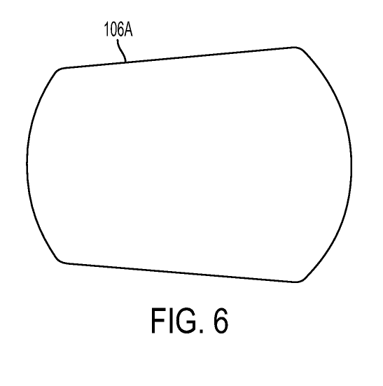

In the embodiment of FIG. 1, the passive interface 106 may be a constant width, W′, along the length (Z-axis) of the T-shaped structure. FIG. 6 is an aerial view of an alternate embodiment of the T-shaped structure of FIG. 1, where the passive interface is tapered along the length of the T-shaped structure. In this alternate embodiment, the T-Slot channel on the active interface (similar to 108) would include a corresponding taper. These tapered interfaces would allow increased misalignment between the second and first components of the alternate embodiment during insertion of the active interface onto the passive interface 106A.

Returning to FIG. 1, the locations of the active and passive interfaces 108, 106 may be interchanged without departing from the scope of the invention. In other words, an acceptable alternative to the disclosed embodiment includes one where the first component 104 includes the channel and the second component 102 includes the corresponding T-shaped structure received within the channel.

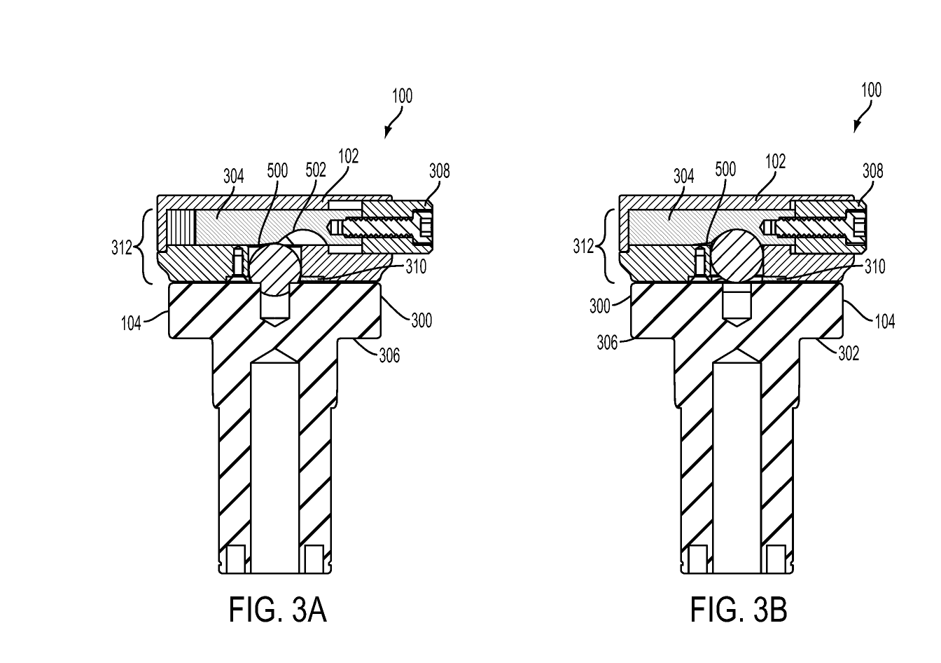

FIG. 3A is a right-side cross sectional view of the manual quick-release latching system 100 of FIG. 1 in a latched state, in accordance with an embodiment of the invention, where the view is taken along plane 3-3 of FIG. 2. FIG. 3B corresponds to FIG. 3A; however the manual quick-release latching system 100 is illustrated in a released state, in accordance with an embodiment of the invention.

As illustrated in the embodiment of FIGS. 3A and 3B, a mating surface 300 of the passive interface 106 may include a semi-spherical, cone, or other shaped socket 302 (best illustrated in FIG. 3B) having its opening in the plane of the mating surface 300. The socket 302 may receive a portion of the ball 306 (preferably less than half of the radius of the ball) when the sliding latch 304 is in the latched state as illustrated in FIG. 3A. In one embodiment, the socket 302 may be configured to receive the ball 306 to a depth that is less than a depth that would prevent the ball 306 from smoothly rolling out of the socket 303 as the second component 102 is slidingly disengaged from the first component 104, when the sliding latch 304 is in the released state of FIG. 3B.

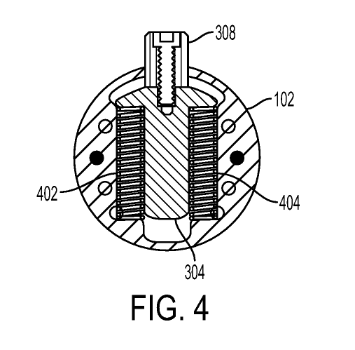

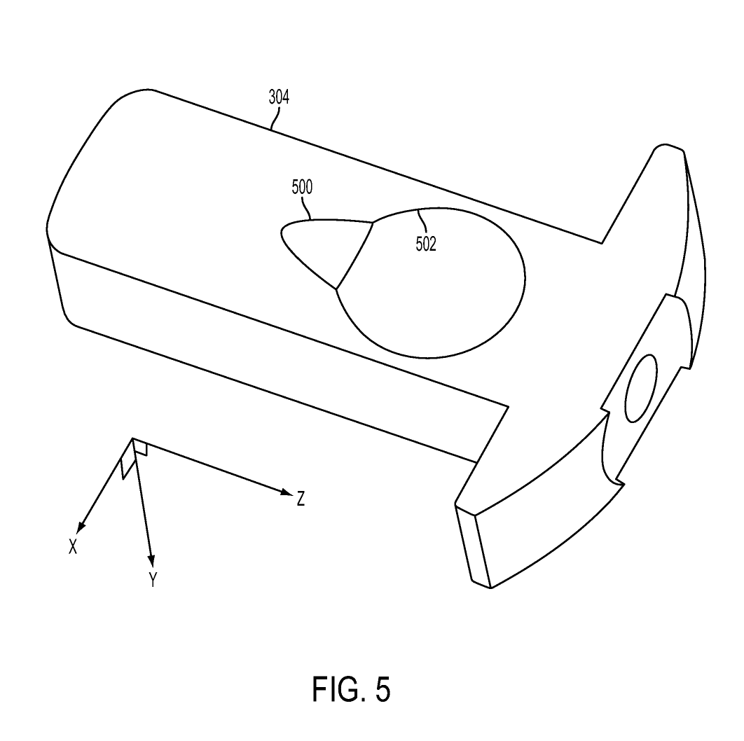

The second component 102 includes a latching mechanism 312. The latching mechanism 312 may include a sliding latch 304, a ball 306, redundant compression springs 402, 404 (FIG. 4), a push-button actuator 308, and a ball retaining plate 310. The latching mechanism may be manually moved from a latched position to a released position by depressing the push-button actuator 308.

FIG. 4 is a top cross-sectional view of a second component of the manual quick-release latching system of FIG. 1 in a latched state, taken along the plane 4-4 of FIG. 1. Several components of the latching mechanism 312 are visible in FIG. 4.

With reference to FIG. 4, the sliding latch 304 may be acted upon by the compression springs 402, 404. In the embodiment described herein, the compression springs 402, 404 are redundant. Each spring alone, may be sufficient to cause the sliding latch 304 latch to remain in the latched state of FIG. 3A when the push-button actuator 308 is not depressed. Accordingly, the manual quick-release latching system 100 may maintain an adequate pre-load upon the ball 306 even if one of the redundant compression springs 402, 404 is broken. The T-shape outline of the sliding latch 304 is one example of a sliding latch. Other shapes are within the scope of the invention. The two-part configuration of the sliding latch 304 and the push-button actuator 308 is one example of such a combination. Other combinations, or a combined sliding latch/push-button actuator, are within the scope of the invention.

FIG. 5 is a perspective view of a bottom side of the sliding latch 304 housed in the second component 102 as illustrated in FIG. 4, in accordance with an embodiment of the invention. The sliding latch 304 may include a shallow ramp 500 that is maintained in contact with a surface of the ball 306 when the manual quick-release latching system 100 is in the latched state, as illustrated in FIG. 3A. The sliding latch 304 may also include a semispherical depression 502 that is configured to receive at least a portion of the ball 306. The depth of the semispherical depression 502 may be sufficient to prevent any portion of the surface of the ball 306 from interfering with the mating surface 300 of the passive interface 106 when the second and first components 102, 104 are slidingly engaged or disengaged with each other while the sliding latch 304 is in the released state of FIG. 3B. In one embodiment, the length and angle of the shallow ramp 500 are 0.150″ and 7°, respectively; the ball diameter is 0.375″; and the depth and diameter of the semispherical depression 502 are 0.110″ and 0.376″, respectively.

Returning to FIG. 3A, in the latched state, the sliding latch 304, by action of the shallow ramp 500 (FIG. 5) and redundant compression springs 402, 404, urges the ball 306 to pass into the socket 302 of the first component 104 beyond a plane of the mating surface 300 of the passive interface 106. The combination of the shallow ramp 500 and the compression springs 402, 404 prevents the ball 306 from back-driving the sliding latch 304. Therefore, in the latched state of FIG. 3A, the sliding latch 304 is prevented from being back-driven into the released state and the ball 306 is prevented from retracting into the second component 102, all due to the ball's position on a shallow ramp 500 (FIG. 5) and the redundant compression springs 402, 404 acting to maintain the ball 306 at its position on the shallow ramp 500.

In the latched state of FIG. 3A, the ball 306 thus interferes with the sliding engagement or disengagement of the active interface 108 relative to the passive interface 106. If slidingly engaged with one another and in the latched state of FIG. 3A, this useful and beneficial feature of the manual quick-release latching system 100 prevents the first and second components 102, 104 from slidingly disengaging from each other. If not slidingly engaged with one another and in the latched state of FIG. 3A, this useful and beneficial feature of the manual quick-release latching system 100 prevents the second and first components 102, 104 from engaging with each other.

Conversely, when the sliding latch 304 is in the released state of FIG. 3B, the ball 306 does not interfere with the sliding engagement or disengagement of the second component 102 with respect to the first component 104. This useful and beneficial feature of the manual quick-release latching system 100 allows the second and first components 102, 104 to slidingly be engaged to (if not already engaged) or disengaged from (if already engaged) each other.

As indicated above, latching mechanism of the second component 102 may include a ball retaining plate 310 that retains the ball 306 when the active interface 102 is separated from the passive interface 104. In alternate embodiments, the ball retaining plate 310 may be configured to act as a spring to urge the ball 306 (or an alternative object) out of the socket 302 when the sliding latch 304 is moved from a latched state to a released state. In still another alternate embodiment, the socket 302 may include a spring (not shown) to urge the ball 306 (or an alternative object) out of the socket 302 when the sliding latch 304 is moved from a latched state to a released state.

As described above, the manual quick-release latching system 100 allows for the latching and releasing of a tool (not shown) from a manipulator (not shown). When tools are coupled to second components 102 and a manipulator arm (not shown) is coupled to a first component 104, tools may be made to slide easily onto and off of the manipulator arm.

In certain embodiments, the first component 104 may be fixed to or a part of the manipulator arm, and second components 102 may be fixed to or part one or more tools. The reverse is also possible, where the second component 102 is fixed to, or a part of the manipulator arm and first components 104 are fixed to or part of one or more tools. The latter configuration may result in the multiple tools having the simpler first components 104 rather then the relatively more complex second components 102.

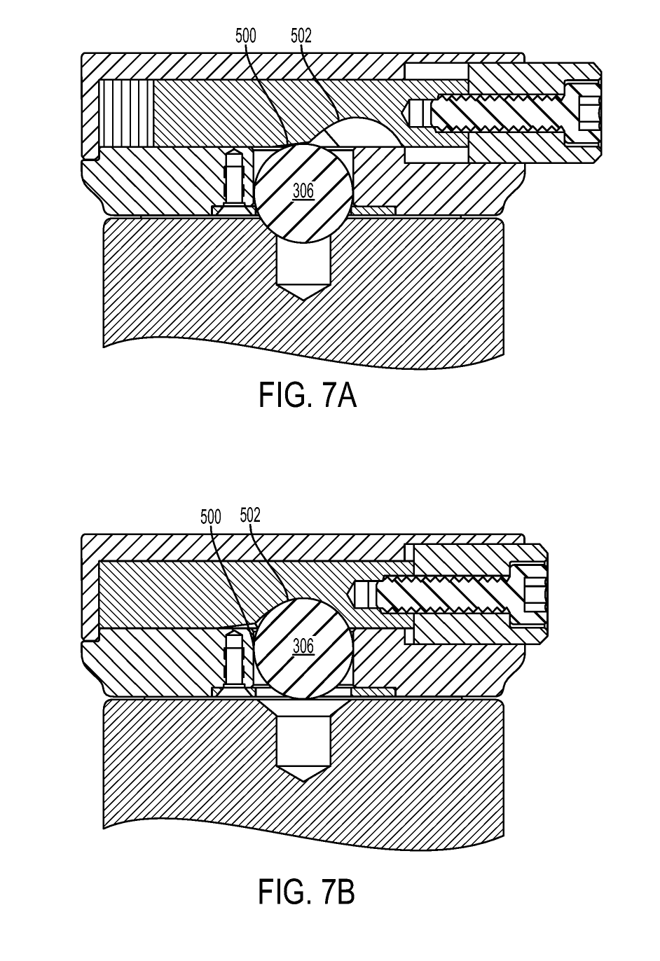

FIGS. 7A and 7B are enlarged views of a portion of FIGS. 3A and 3B, respectively. The ball 306, the shallow ramp 500, and the semispherical depression 502 are specifically identified in the illustrations.

It will be apparent to those skilled in the art that various modifications and variation can be made in the present invention without departing from the spirit or scope of the invention. Thus, it is intended that the present invention cover the modifications and variations of this invention provided they come within the scope of any claims and their equivalents.

As a person skilled in the art will recognize from the previous detailed description and from the figures and claims, modifications and changes can be made to the preferred embodiment of the invention without departing from the spirit or scope of this invention defined in the following claims. Thus, it is intended that the present invention cover the modifications and variations of this invention provided they come within the scope of any claims and their equivalents.

What is claimed is:

1. A latching system, comprising:
a first component, comprising
at least one first component mating surface,
a socket recessed into the first component and having an opening on the first component mating surface; and
at least one first component retaining structure; and
a second component, separate from the first component, the second component comprising:
at least one second component mating surface, configured to be juxtaposed to the first component mating surface when the first component is slidingly engaged with the second component,
at least one second component retaining structure, configured to slidingly engage the first component retaining structure when the first component is slidingly engaged with the second component in a first direction and interlock the first component with the second component in a direction perpendicular to the first direction, and
a latching mechanism comprising a part configured to partially extend outward from the second component mating surface in a direction perpendicular to the second component mating surface and fit into the socket to latch the first component with the second component by preventing the first component from sliding with respect to the second component in the first direction.

2. The latching system of claim 1, wherein the part is a ball and the latching mechanism further comprises:
a sliding latch, configured to slide in a linear direction;
at least one compression spring, configured to force the latch toward a first position when the compression spring is in a nominal state; and
a push-button actuator, configured to compress the compression spring and move the latch in the linear direction toward a second position, distal to the first position, when the push-button actuator is depressed.

3. The latching system of claim 2, wherein the latching mechanism further comprises:
a ball retaining plate configured to allow the partial extension of the ball from the second component mating surface and retain the ball from completely extending past the second component mating surface.

4. The latching system of claim 2, wherein the latching mechanism further comprises:
an additional compression spring, to provide compression spring redundancy.

5. The latching system of claim 2, wherein the sliding latch comprises a shallow ramp configured to maintain contact with a surface of the ball when the first component is slidingly engaged with the second component and the first component is latched to the second component due to the partial extension of the ball from the second component mating surface and fitting into the socket

6. The latching system of claim 2, wherein the sliding latch further comprises a depression configured to receive at least a portion of the ball, wherein a depth of the depression allows the ball to retract inward in a direction away from the socket to allow an outermost surface of the ball to not break a plane parallel to the second component mating surface.

7. The latching system of claim 1, wherein the at least one second component retaining structure is an undercut channel and wherein the at least one first component retaining structure is a T-shaped structure configured to slidingly engage the second component retaining structure.

8. The latching system of claim 1, wherein the at least one second component retaining structure and the at least one first component retaining structure comprise a dovetail joint.
